(19) United States
(12) Patent Application Publication
(10) Pub. No.: US 2009/0254952 A1
(43) Pub. Date: Oct. 8, 2009

(54) IPTV Network with D-Server Controller, VoD-Server Controller and Policy Server that Implement Diagnostic Tools

(75) Inventors: Kamakshi Sridhar, Plano, TX (US); Hakki C. Cankaya, Dallas, TX (US); Gerard Damm, Plano, TX (US)

Correspondence Address: Law Office of WILLIAM J. TUCKER, 2631 Lakeforest Ct., Dallas, TX, 75214, US

(73) Assignee: Alcatel Lucent, Paris (FR)

(21) Appl. No.: 12/061,525

(22) Filed: Apr. 2, 2008

(51) Int. Cl. H04N 7/173

(52) U.S. Cl. 725/92

(57) ABSTRACT

A D-server controller, a VoD-server controller and a policy server are described herein which implement diagnostic tools that proactively detect and prevent potential problems with different components and services in an Internet Protocol Television (IPTV) network.

### TECHNICAL FIELD

The present invention is related to a D-server controller, a VoD-server controller and a policy server which implement diagnostic tools that proactively detect and prevent potential problems with different components and/or services in an IPTV network.

### DESCRIPTION OF RELATED ART

The following abbreviations are herewith defined, at least some of which are referred to in the ensuing description of the prior art and the description of the present invention.
BTV Broadcast Television
CO Central Office
DSL Digital Subscriber Line
DSLAM Digital Subscriber Line Access Multiplexer
IEEE Institute of Electrical and Electronics Engineers
IGMP Internet Group Management Protocol
IP Internet Protocol
IPTV Internet Protocol Television
OLT Optical Line Termination
ONT Optical Network Termination
OSS Operations Support System
RGW Residential Gateway
SAI Service Area Interface
SHO Super Headend Office
SNMP Simple Network Management Protocol
STB Set-Top Box
TV Television
UDP User Datagram Protocol
VHO Video Hub Office
VLAN Virtual Local Area Network
VoD Video-On-Demand

Referring to FIG. 1 (PRIOR ART), there is a block diagram that illustrates the basic components of an exemplary IPTV network 100 which provides broadcast TV channels to homes via for example optical fiber or DSL phone lines. The exemplary IPTV network 100 shown includes two SHOs 102 (including an A-server 103), a backbone network 104 (including a policy server 105), multiple VHOs 106 (including a D-server controller 107a, D-server clusters 107b and 107b′, VoD-server controller 107c, VoD-server clusters 107d and 107d′, and an A-server 107e), multiple IOs 108, multiple COs 110, multiple SAIs 112 (DSLAMs 112, ONTs/OLTs 112) and multiple RGWs 114. The RGWs 114 are connected to STBs 116 which are connected to television sets 118 (or other monitors) that are located in the homes of subscribers 120.

In operation, each SHO 102 receives international/national TV feeds and supplies those international/national TV feeds via the backbone network 104 to each VHO 106. Then, each VHO 106 receives regional/local TV feeds and multicasts all of the TV feeds to their respective IOs 108. And, each IO 108 then multicasts all of the TV feeds to their respective COs 110. Then, each CO 110 multicasts all of the TV feeds to their respective SAIs 112. And, each SAI 112 then sends one or more TV feeds to their respective RGWs 114 and STBs 116 (note: if a SAI 112 is in a situation where no subscribers 120 are watching a TV channel then that SAI 112 would not send any TV feeds to their respective RGWs 114 and STBs 116). Thus, each subscriber 120 can interface with their STB 116 and select one of the multicast TV channels to watch on their television set 118 (or other monitor). If desired, each subscriber 120 can interface with their STB 116 and select a VoD to watch on their television set 118 (or other monitor).

The various servers 103, 105 and 107a . . . 107e help to provide video delivery services to the subscribers 120. In particular, the A-servers 103 and 107e stream BTV content to the STBs 116. The D-server controller 107a manages the D-server clusters 107b and 107b′ (each have multiple D-servers) which are used for fast channel change and retransmission of errored/missing packets to the STBs 116. The VoD-server controller 107c manages the VoD-server clusters 107d and 107d′ (each have multiple VoD-servers) which are used to unicast-stream a video file, such as a movie, to particular STB(s) 116 used by subscriber(s) 120 who paid money to watch that particular movie. The policy server 105 decides whether a request from a particular subscriber 120 for a service or an upgrade should be allowed based on static and dynamic rules.

The traditional D-server controller 107a and the traditional VoD-server controller 107c have some form of elementary management, such as MOM (Microsoft Operations Management), which provides for the basic management of the individual servers and also provides the tools for the load-balancing between the individual servers. Plus, the D-server controller 107a and the VoD-server controller 107c each have diagnostics tools that allow the inspection of their operational status, their utilization rate, and the distribution of load among the primary servers in their respective cluster according to arriving requests. However, the existing diagnostic tools do not provide extended capabilities which would proactively detect and prevent potential problems for the architecture and/or services of the IPTV network 100. For example, the existing diagnostic tools lack of proactive detection capabilities can lead to several problems:

1. There is no way to inform the STBs 116 about failures of the D-server(s) 107b and 107b′.

2. There is no way to ensure that popular channels are on a proportional number of the D-servers 107b and 107b′ or the VoD-servers 107d and 107d′.

3. There is no way to ensure the load balancing in the D-servers 107b and 107b′ and the VoD-servers 107d and 107d′ is done according to arriving requests.

4. If a server 107b, 107b′, 107d and 107d′ failure happens, the existing diagnostic tools have recovery tools to ensure service continuity but these existing diagnostic tools will not ensure optimal performance while there is a degraded situation.

Also, the traditional policy server 105 and its resulting policy enforcement applies in only one direction which is from the policy server 105 to the downstream network nodes 106, 108, 110, 112, 114 and 116. This happens because the current policy server 105 is assumed to be completely trustworthy. However, the policy server 105 and the corresponding policy enforcement could be functioning as they are supposed to, but this does not necessarily mean that the subscriber 120 is receiving the service as expected. For instance, the policy server 105 may think everything is functioning as requested but not be aware that there is a problem with the subscribers 120 reception which may be caused by a misconfiguration and/or a temporary congestion within the IPTV network 100. In particular, the traditional policy server 105 does not have a diagnostic tool which can check if the subscriber 120 would indeed be able to receive the service as understood by the policy server 105.

Accordingly, there is a need for new proactive diagnostic tools which address the aforementioned shortcomings with the traditional diagnostic tools in the IPTV network. This need and other needs are satisfied by an enhanced policy server, an enhanced D-server controller and an enhanced VoD-server controller which implement new proactive diagnostic tools in accordance with the present invention.

### SUMMARY

In one aspect, the present invention provides a method for proactively testing an IPTV network by: (a) proactively detecting a potential problem with at least one component or at least one service within the IPTV network; and (b) proactively preventing the potential problem with the at least one component or the at least one service within the IPTV network. In particular, the method can implement seven different diagnostic tools that can be used individually or in any combination to proactively test and prevent problems in the IPTV network.

In another aspect, the present invention provides a server (e.g., D-server controller, VoD-server controller, policy server) that implements at least one diagnostic tool to proactively test an IPTV network. Each server has a memory that stores processor-executable instructions, and a processor that interfaces with the memory and executes the processor-executable instructions to effectuate performance of at least one diagnostic test comprising: (a) proactively detecting a potential problem with at least one component or at least one service within the IPTV network; and (b) proactively preventing the potential problem with the at least one component or the at least one service within the IPTV network. In particular, the D-server controller can implement up to three diagnostic tools to proactively test and prevent problems within the IPTV network. The VoD-server controller can implement up to three diagnostic tools to proactively test and prevent problems within the IPTV network. And, the policy server can implement one diagnostic tool to proactively test and prevent problems within the IPTV network.

In yet another aspect of the present invention an IPTV network is provided that has a D-server controller, a VoD-server controller and a policy server that implement different diagnostic tools. The D-server controller proactively detects and prevents potential problems by implementing: (a) a first diagnostic tool that retrieves information about a failure or a repair of a D-server, and informs at least one affected Set-Top-Box (STB) about the failed or repaired D-server, wherein the at least one affected STB then arranges a D-server list to take into account the failed or repaired D-server; (b) a second diagnostic tool that verifies every Broadcast Television (BTV) channel is in at least one D-Server, and verifies that a number of the D-servers where each BTV channel resides is proportional to a demand of the STBs; and/or (c) a third diagnostic tool that retrieves Instant Channel Change (ICC) requests and retransmission requests sent by the STBs, and load-balances the D-Servers if needed based on the retrieved ICC requests and retransmission requests to spread retransmission traffic across the D-Servers. The VoD-server controller proactively detects and prevents a potential problem by implementing: (a) a fourth diagnostic tool that detects a failure of a VoD-server, locates each STB which has the failed VoD-server assigned as a secondary server, and instructs the located STB(s) to replace a secondary Internet Protocol (IP) address (or some other identifier) for the failed VoD-server with a new IP address (or some other identifier) for a new VoD-server which contains a copy of desired content; (b) a fifth diagnostic tool which verifies that a specific content is on at least two VoD-servers, and verifies that a number of VoD-servers owning the specific content is proportional to a current demand for the specific content by the STBs; and/or (c) a sixth diagnostic tool that verifies a new load on both secondary and primary VoD-servers of each STB is balanced after one of a plurality of VoD-servers has failed or has been repaired. The policy server proactively detects and prevents a potential problem by implementing: (a) a seventh diagnostic tool that checks if a subscriber is indeed receiving a service as was previously determined by the policy server.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 (PRIOR ART) is a diagram of an exemplary IPTV network which has a traditional policy server, a traditional D-server controller, and a traditional VoD-server controller that are used to provide broadcast TV channels and VoD movies to homes via for example optical fiber or DSL phone lines;

FIG. 2 is a diagram of an exemplary IPTV network which has an enhanced policy server, an enhanced D-server controller and an enhanced VoD-server controller which implement new diagnostic tools in accordance with the present invention;

FIG. 3 is a diagram used to help explain how the enhanced D-server controller implements a first diagnostic tool to proactively detect and prevent potential problems within the IPTV network in accordance with an embodiment of the present invention;

FIG. 4 is a diagram used to help explain how the enhanced D-server controller implements a second diagnostic tool to proactively detect and prevent potential problems within the IPTV network in accordance with an embodiment of the present invention;

FIG. 5 is a diagram used to help explain how the enhanced D-server controller implements a third diagnostic tool to proactively detect and prevent potential problems within the IPTV network in accordance with an embodiment of the present invention;

FIG. 6 is a diagram used to help explain how the enhanced VoD-server controller implements a fourth diagnostic tool to proactively detect and prevent potential problems within the IPTV network in accordance with an embodiment of the present invention;

FIG. 7 is a diagram used to help explain how the enhanced VoD-server controller implements a fifth diagnostic tool to proactively detect and prevent potential problems within the IPTV network in accordance with an embodiment of the present invention;

FIG. 8 is a diagram used to help explain how the enhanced VoD-server controller implements a sixth diagnostic tool to proactively detect and prevent potential problems within the IPTV network in accordance with an embodiment of the present invention; and

FIG. 9 is a diagram used to help explain how the enhanced policy server implements a seventh diagnostic tool to proactively detect and prevent potential problems within the IPTV network in accordance with an embodiment of the present invention.

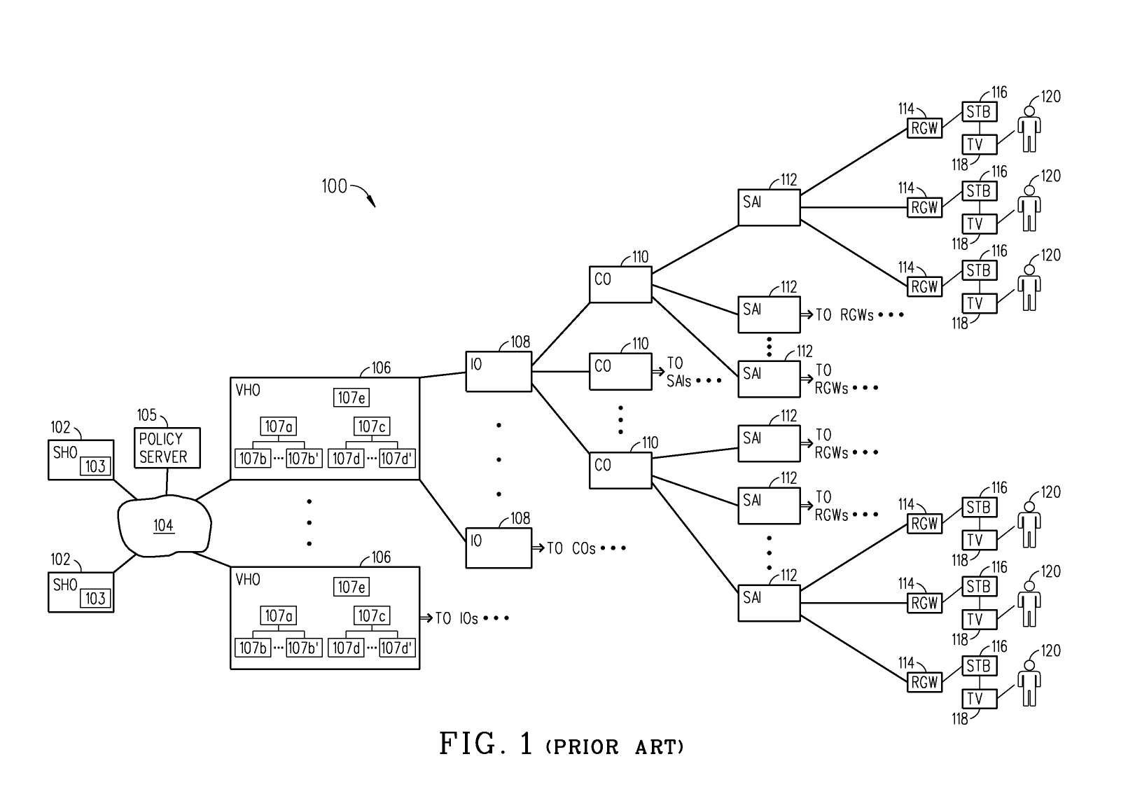

### DETAILED DESCRIPTION

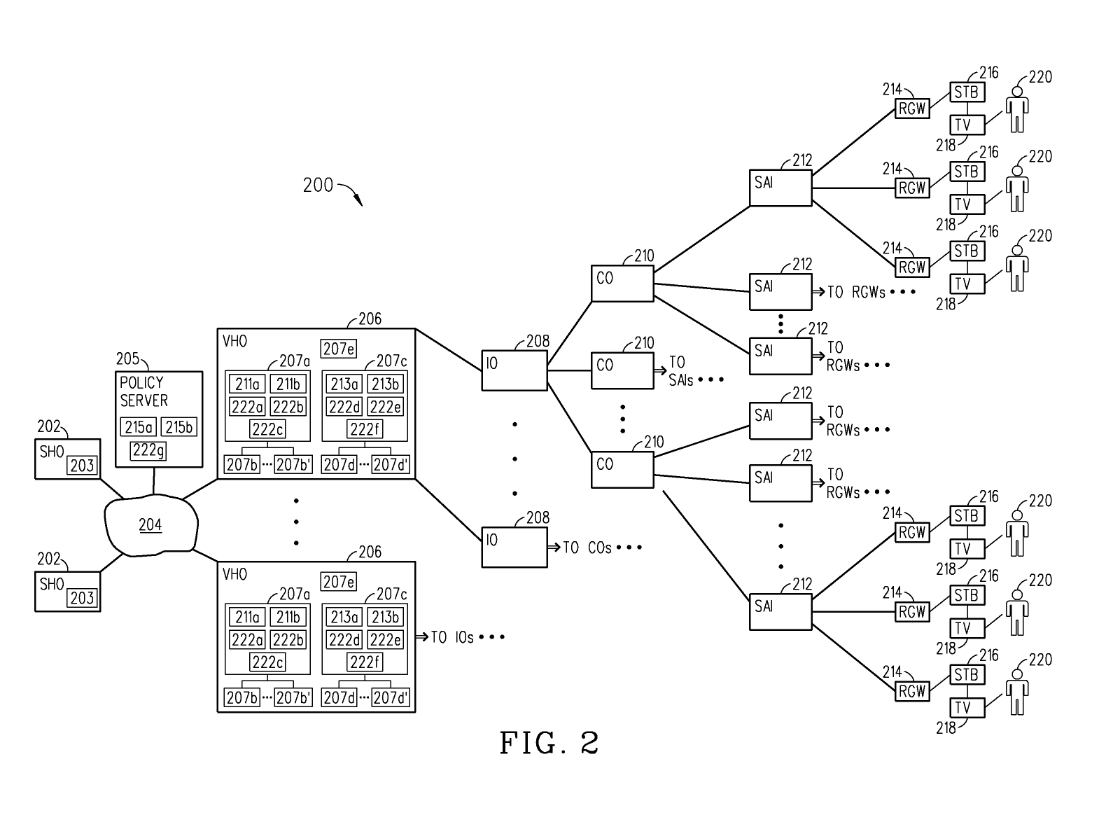

Referring to FIG. 2, there is a block diagram that illustrates the basic components of an exemplary IPTV network 200 which has an enhanced policy server 205, an enhanced D-server controller 207a and an enhanced VoD-server controller 207c which implement new diagnostic tools 222a, 222b . . . 222g in accordance with the present invention. The exemplary IPTV network 200 shown includes two SHOs 202 (including an A-server 203), a backbone network 204 (including an enhanced policy server 205), multiple VHOs 206 (including an enhanced D-server controller 207a, D-server clusters 207b and 207b′, an enhanced VoD-server controller 207c, VoD-server clusters 207d and 207d′, and an A-server 207e), multiple IOs 208, multiple COs 210, multiple SAIs 212 (DSLAMs 212, ONTs/OLTs 212) and multiple RGWs 214. The RGWs 214 are connected to STBs 216 which are connected to television sets 218 (or other monitors) that are located in the homes of subscribers 220.

In operation, each SHO 202 receives international/national TV feeds and supplies those international/national TV feeds via the backbone network 204 to each VHO 206. Then, each VHO 206 receives regional/local TV feeds and multicasts all of the TV feeds to their respective IOs 208. And, each IO 208 then multicasts all of the TV feeds to their respective COs 210. Then, each CO 210 multicasts all of the TV feeds to their respective SAIs 212. And, each SAI 212 then sends one or more of the TV feeds to their respective RGWs 214 and STBs 216 (note: if a SAI 212 is in a situation where no subscribers 220 are watching a TV channel then that SAI 212 would not send any TV feeds to their respective RGWs 214 and STBs 216). Thus, each subscriber 220 can interface with their STB 216 and select one of the multicast TV channels to watch on their television set 218 (or other monitor). If desired, each subscriber 220 can interface with their STB 216 and select a VoD to watch on their television set 218 (or other monitor).

The various servers 203, 205 and 207a . . . 207e help to provide video delivery services to the subscribers 220. In particular, the A-servers 203 and 207e stream BTV content to the STBs 216. The D-server controller 207a manages the D-server clusters 207b and 207b′ (which have multiple D-servers) that are used for fast channel change and retransmission of errored/missing packets to the STBs 216. The VoD-server controller 207c manages the VoD-server clusters 207d and 207d′ (which have multiple VoD-servers) that are used to unicast-stream a video file, such as a movie, to particular STB(s) 216 used by subscriber(s) 220 who paid money to watch that particular movie. The policy server 205 decides whether a request from a particular subscriber 220 for a service or an upgrade should be allowed based on static and dynamic rules.

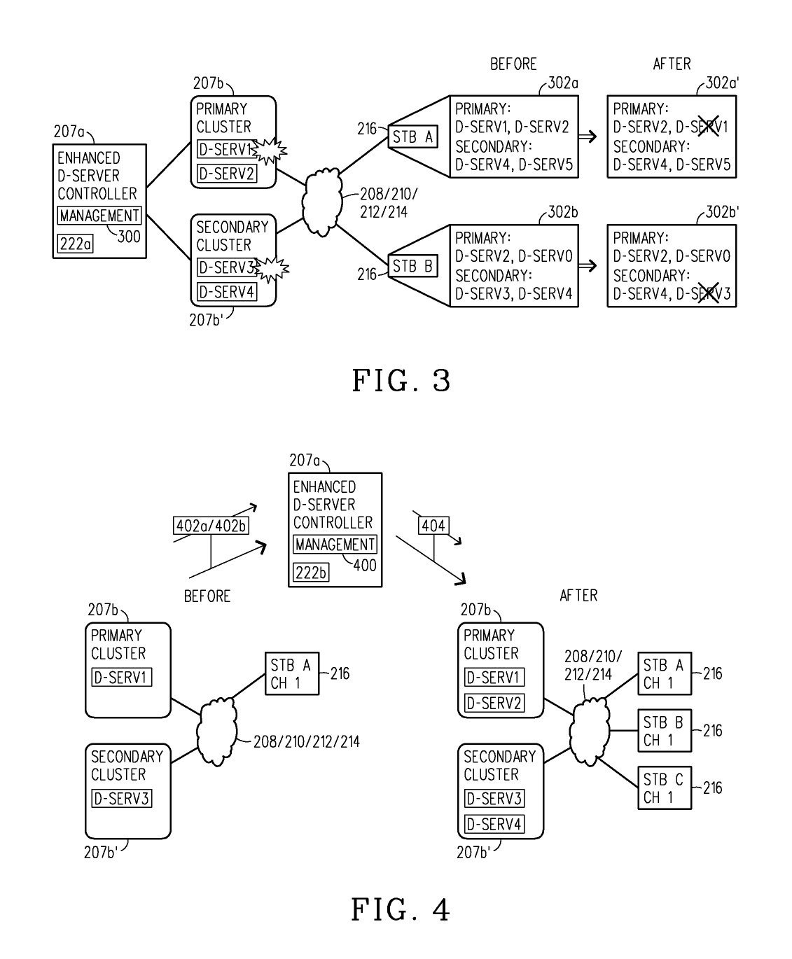

In the present invention, the video delivery and policy servers 205, 207a and 207c also implement seven high-level diagnostics tools 222a, 222b . . . 222g that proactively detect and prevent potential problems for the architecture and/or the services within the IPTV network 200. In particular, the enhanced D-server controller 207a implements three high-level diagnostics tools 222a, 222b and 222c. The enhanced VoD-server controller 207c implements three high-level diagnostics tools 222d, 222e and 222f. And, the enhanced policy server 205 implements one high-level diagnostics tool 222g. Each of the seven high-level diagnostics tools 222a, 222b . . . 222g are discussed in detail below with respect to FIGS. 3-9.

### 1. Diagnostic Tool 222a (“DServ Failure Notification”):

Basic Idea: The enhanced D-server controller 207a implements this diagnostic tool 222a to detect a failure of one or more D-servers in clusters 207b and 207b′ and then to proactively inform the affected STBs 216 to avoid unnecessary attempts from those STBs 216 to connect to the failed D-server(s) in clusters 207b and 207b′.
Background/Problem: Each STB is given two primary and two secondary D-server IP addresses (or other identifiers) at boot time. The STBs connect to their first primary D-server identified in their D-server list via a UDP session without a permanent connection. Unfortunately, the STBs are not notified of a D-server failure, if they are not currently using the failed D-server. Therefore, after a D-server failure, the STBs attempt to connect to this failed D-server will be unknowingly futile attempts. The failed D-server may be a primary D-server or a secondary D-server.
Solution: The enhanced D-server controller 207a implements diagnostic tool 222a and proactively informs the affected STBs 216 when there is a failure with one or more D-servers in clusters 207b and 207b′ and after the one or more failed D-servers in clusters 207b and 207b′ have been repaired. In particular, the diagnostic tool 222a detects a D-server failure event where this information could, for example, be retrieved from an Element Management System's (EMS) Management Information Base (MIB) via a Trap. In fact, the information about the D-server failure event can be retrieved from a data structure in a management system 300 of the enhanced D-server controller 207a. In the event of a D-server failure, the enhanced D-server controller 207a informs the affected STBs 216 that have this particular D-server in their D-server lists. The affected STBs 216 then arrange their D-server lists accordingly to avoid connecting to the failed D-server. Thus, all unnecessary attempts to contact a failed D-server which cause extra traffic and delay to the IPTV network 200 are avoided. Similarly, the diagnostic tool 222a can detect a D-server repair event and then communicate this information to the affected STBs 216 to indicate the availability of the previously unavailable D-server.
Example: FIG. 3 is provided to help explain how the diagnostic tool 222a detects failed D-Servers namely D-serv1 and D-serv3 and then proactively informs the affected STBs A and B. In this example, assume STB A prior to any D-server failures has a D-server list 302a with assigned primary servers D-serv1 and D-serv2 and secondary servers D-serv4 and D-serv5. And, assume the STB B has a D-server list 302b with assigned primary servers D-serv2 and D-serv0 and secondary servers D-serv3 and D-serv4. Then, the diagnostic tool 222a detects failures in two D-servers which in this example are D-serv1 and D-serv3. In one embodiment, the diagnostic tool 222a retrieves this failure information from an Element Management System's (EMS) Management Information Base (MIB) via a Trap. Then, the diagnostic tool 222a informs the affected STBs A and B which have these failed D-servers in their modified D-server lists 302a′ and 302b′. These STBs A and B then arrange their D-server lists 302a′ and 302b′ accordingly to avoid connecting to the failed D-servers. In the example, STB A after the D-server failures have been detected has a D-server list 302a′ with assigned primary servers D-serv2 and D-serv1 and secondary servers D-serv4 and D-serv5. And, STB B has a D-server list 302b′ with assigned primary servers D-serv2 and D-serv0 and secondary servers D-serv4 and D-serv3. In this way, the diagnostic tool 222a avoids the unnecessary events which potentially cause extra traffic and delay to the IPTV system 200. Similarly, the diagnostic tool 222a detects repair event(s) and communicates this to the STBs A and B to indicate the availability of the previously unavailable D-server(s).

### 2. Diagnostic Tool 222b (“DServ_feed”):

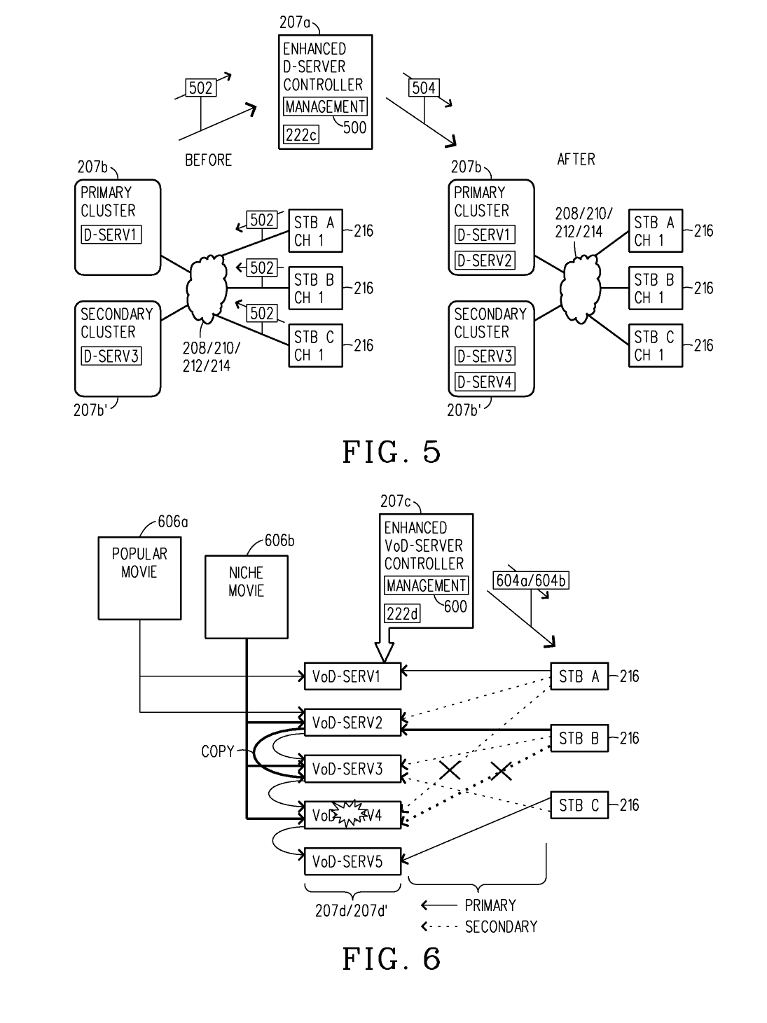

Basic Idea: The enhanced D-server controller 207a implements this diagnostic tool 222b to verify that the number of D-servers in clusters 207b and 207b′ on which content resides is proportional to the demand by the STBs 216.
Background/Problem: Each BTV channel has to exist on at least one D-Server to provide service. The D-server to provide service for a particular BTV channel must issue an IGMP Report to join that BTV channel (note: IGMP Report is related to an IGMP Join since it is used for joining (i.e. to be a listener of a multicast address). A BTV channel may reside on several D-servers to create redundancy. However, the traditional D-server controller does not verify that the number of D-servers on which content is residing is proportional to the demand by the STBs.
Solution: The D-server controller 207a implements diagnostic tool 222b which verifies the following: (1) that every BTV channel is in at least one D-Server in clusters 207b and 207b′; and (2) the number of D-servers in clusters 207b and 207b′ where a particular BTV channel resides is proportional to the demand of the STBs 216. In one embodiment, the diagnostic tool 222b can verify that every BTV channel is in at least one D-Server in clusters 207b and 207b′ and determine the demand of the BTV channels by STBs 216 by looking up an IGMP join membership table via SNMP. This is possible because the D-server controller 207a has a management system 400 that keeps track of important events (for instance by snooping) and records the IGMP Join messages to maintain status information about the usage of BTV channels. The diagnostic tool 222b uses this information to ensure that the least popular BTV channels would reside on the smallest number of D-servers in clusters 207b and 207b′ and the most popular BTV channels would reside on the largest number of D-servers in clusters 207b and 207b′.
Example: FIG. 4 is provided to help explain how the diagnostic tool 222b verifies that the number of D-servers in clusters 207b and 207b′ on which content is residing is proportional to the demand of the STBs A, B and C. First, the diagnostic tool 222b verifies that BTV channel 1 resides in one primary D-serv1 and one secondary D-serv3 for one STB A (see part of drawing labeled “before”). This is possible because the diagnostic tool 222b has a management system 400 that indicates only STB A has issued an IGMP Join message 402a to use BTV channel 1. Since STB A is the only one viewing BTV channel 1, the diagnostic tool 222b determines that the number of D-servers namely primary D-serv1 and second D-serv3 is proportional to the demand of the STB A. Second, the diagnostic tool 222b after a predetermined amount of time re-checks the management system 400 and learns that STBs A, B and C all have issued IGMP Join messages 402b to receive BTV channel 1 and also verifies that BTV channel 1 currently resides in one primary D-serv1 and one secondary D-serv3. Since there are now more STBs A, B and C using BTV channel 1, the diagnostic tool 222b determines to add additional D-servers namely primary D-serv2 and secondary D-serv4 such that BTV channel 1 resides on four D-servers namely primary D-serv1, primary D-serv2, secondary D-serv3 and secondary D-serv4. The diagnostic tool 222b does this by sending an adjust D-serv message 404 to primary D-serv1, primary D-serv2, secondary D-serv3 and secondary D-serv4 (see part of drawing labeled “after”). In this case, the diagnostic tool 222b has ensured that BTV channel 1 resides on a number of D-servers that is proportional to the demand of the STBs A, B and C.
   3. Diagnostic Tool 222c (“DServ_load balance”):
Basic Idea: The enhanced D-server controller 207a implements this diagnostic tool 222c to ensure that the total ICC (Instant Channel Change) and retransmission requests received from STBs 216 are load-balanced among D-Servers in clusters 207b and 207b′.
Background/Problem: STBs contact D-servers for their ICC requests and retransmission requests based on their allocated D-server IP addresses (or some other identifier). Unfortunately, the ICC and retransmission requests from all of the STBs may go to only a subset of the D-servers, resulting in an unbalanced solicitation of the D-servers.
Solution: The D-server controller 207a implements diagnostic tool 222c to ensure that the total ICC (Instant Channel Change) and retransmission requests 502 received from STBs 216 results in a proper load-balance among D-servers in clusters 207b and 207b′. In one embodiment, the STBs 216 send the ICC and retransmission requests 502 to the same set of D-servers in clusters 207b and 207b that contain a particular BTV channel which has lost packets (see FIG. 5). Then, this information 502 is sent to a management system 500 associated with the D-server controller 207a. The diagnostic tool 222c retrieves and analyzes this information 502 and if this traffic is within an absolute threshold (for example) then no changes are made. However, if the diagnostic tool 222c determines that this traffic is not within the absolute threshold then an alarm is raised and/or some reconfiguration action is enforced such as sending new D-server IP addresses (or some other identifier) to the STBs 216 and/or forcing more D-servers in clusters 207b and 207b′ to join this BTV channel to spread out the retransmission traffic.
Example: FIG. 5 is provided to help explain how the diagnostic tool 222c measures the per-BTV channel traffic at the D-Server level, and raises an alarm and/or initiates a reconfiguration action if an excess of ICC requests or retransmission requests are detected. In this example, the STBs A, B and C are experiencing a problem with BTV channel 1 and send ICC and retransmission requests 502 to their primary D-serv1 and second D-serv3 (see part of drawing labeled “before”). Then, this information 502 is sent to a management system 500 associated with the D-server controller 207a. The diagnostic tool 222c retrieves and analyzes this information 502 and then determines that this traffic is not within an absolute threshold (for example) so changes should be made to address this problem. In this example, the diagnostic tool 222c determines to add additional D-servers primary D-serv2 and D-serv4 such that BTV channel 1 resides on four D-servers namely primary D-serv1, primary D-serv2, secondary D-serv3 and secondary D-serv4. The diagnostic tool 222c does this by sending an adjust D-serv message 504 to primary D-serv1, primary D-serv2, secondary D-serv3 and secondary D-serv4 (see part of drawing labeled “after”). In this case, the diagnostic tool 222c has effectively ensured that future ICC and retransmission traffic received from STBs A, B and C will be load-balanced among D-Servs 1, 2, 3 and 4. If desired, the diagnostic tool 222c can also modify or rearrange the STB's list of primary/secondary D-servers based on the received ICC traffic and the received retransmission traffic.
   4. Diagnostic Tool 222d (“VServ_failure notification”):
Basic Idea: The enhanced VoD-server controller 207c implements this diagnostic tool 222d to proactively notify affected STBs 216 about a failure of a secondary VoD-server in clusters 207d and 207d′.
Background/Problem: A VoD-server could be primary to one STB and a secondary to another STB. Thus, when a VoD-server failed, then the STBs which used the failed VoD-server as their primary would switch to their secondary VoD-server. This is not a problem. However, when a VoD-server failed, then the STBs which had this particular server as a secondary would not be aware of the failed secondary VoD-server unless there was some sort of TCP connection maintained between the affected STB(s) and the failed VoD-server. This is a problem.
Solution: The VoD-server controller 207c implements diagnostic tool 222d to proactively notify affected STBs 216 about a failure of their secondary VoD-server in clusters 207d and 207d′. In particular, the diagnostic tool 222d detects a failure of a VoD-server in clusters 207d and 207d′ using the VoD-server controller's management tool 600 and then locates all of the STBs 216 which have the failed VoD-server in clusters 207d and 207d′ assigned as their secondary server. Then, the diagnostic tool 222d sends a message to instruct those STBs 216 to replace their secondary IP address for the old VoD-server in cluster 207d or 207d′ with a new secondary IP address for a new VoD-server in cluster 207d or 207d′ which contains a copy of the desired content. If there is no VoD-server in cluster 207d or 207d′ currently available that contains the desired content, then the diagnostic tool 222d makes sure actions are taken by the VoD-server controller 207c to issue “copy” commands, so that a new VoD server in cluster 207d or 207d′ becomes available to be assigned to the affected STBs 216. In this way, the affected STB's VoD-server list becomes updated with the IP address of the new secondary VoD-server in cluster 207d or 207d′. As a result, if any of these affected STBs 216 has to switch to its secondary VoD server in cluster 207d or 207d′ it would be operational right away. This will save the IPTV network 200 from experiencing an extra delay and extra traffic by avoiding unnecessary connection attempts by a STB 216 to connect to a failed secondary VoD-server in cluster 207d or 207d′.
Example: FIG. 6 is provided to help explain how the diagnostic tool 222d proactively notifies affected STBs 216 about a failure of their secondary VoD-server in cluster 207d or 207d′. In this example, the diagnostic tool 222d detects a failure of a VoD-serv4 using the VoD-server contoller's management tool 600 and then determines that STBs A and B have the failed VoD-serv4 assigned as their secondary server. STB C is not impacted since the failed VoD-serv4 is not its secondary server. Then, the diagnostic tool 222d sends a message 604a to instruct the affected STB A to replace the old secondary IP address (or other identifier) for the old secondary VoD-serv4 with a new IP address for a new secondary VoD-serv2 which contains a copy of the desired popular movie 606a. The diagnostic tool 222d also sends a message 604b to instruct the affected STB B to replace the old IP address for the old secondary VoD-serv4 with a new IP address for a new secondary VoD-serv3 which contains a copy of the desired niche movie 606b. In this case, VoD-server 3 did not originally have a copy of the desired niche movie 606b so the diagnostic tool 222d makes sure actions are taken by the VoD-server controller 207c to issue a “copy” command, so that the new VoD-serv3 has the content which may be needed by the STB B.

### 5. Diagnostic Tool 222e (“VServ_content”):

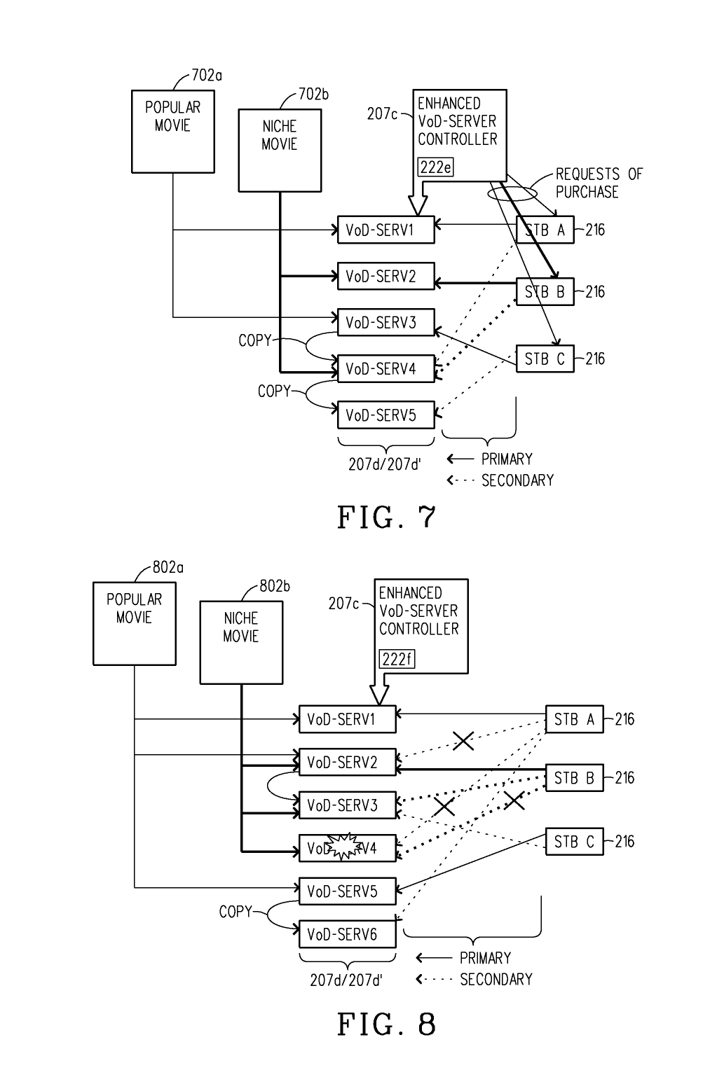

Basic Idea: The enhanced VoD-server controller 207c implements this diagnostic tool 222e to verify the content allocation on the VoD-servers in clusters 207d and 207d′. In particular, the diagnostic tool 222e verifies: (1) the content (e.g., movie) is on at least 2 VoD-servers in clusters 207d and 207d′; and (2) the number of VoD-servers in clusters 207d and 207d′ owning a content (e.g., movie) is proportional to its demand by the STBs 216.
Background/Problem: When an on-demand movie purchase is made, the subscriber's STB sends a request to the VoD-server controller. In return, the VoD-server controller provides the STB with two IP addresses (or other identifiers) for the primary and secondary VoD-servers. Then, the STB contacts the primary VoD-server to receive the on-demand movie. In case it is not responsive, the STB tries the secondary VoD-server. If both fail, the STB consults the VoD-server controller again to obtain a second pair of IP addresses for VoD-servers. This process is not desirable.
Solution: The VoD-server controller 207c implements diagnostic tool 222e to verify: (1) the content (e.g., movie) is on at least two VoD-servers in clusters 207d and 207d′; and (2) the number of VoD-servers in clusters 207d and 207d′ owning a content (e.g., movie) is proportional to its demand from the STBs 216. First, the diagnostic tool 222e verifies that each content (e.g., movie), regardless of its popularity, is deployed to at least two VoD-servers in clusters 207d and 207d′. If this condition is not met, then the diagnostic tool 222e instructs the VoD-server controller 207c to issue a command to copy the content from the SHO 202 to one or more new VoD-server(s) in clusters 207d and 207d′ for redundancy. Second, the diagnostic tool 222e checks that the actual number of VoD-servers in clusters 207d and 207d′ owning a given content is consistent with the current level of demand by the STBs 216 for that particular content. This step involves the correlation of information between the VoD-server controller 207c and the individual VoD-server clusters in clusters 207d and 207d′. If this condition is not met, then the diagnostic tool 222e instructs the VoD-server controller 207c to issue a command to copy the content from the SHO 202 to one or more new VoD-server(s) in clusters 207d and 207d′.
Example: FIG. 7 is provided to help explain how the diagnostic tool 222e verifies: (1) the content (e.g., movies) is on at least two VoD-servers in clusters 207d and 207d′; and (2) the number of VoD-servers in clusters 207d and 207d′ owning a content (e.g., movie) is proportional to its demand from the STBs 216. In this example, the diagnostic tool 222e verifies that the popular movie 702a is on two VoD-servs 1 and 3 and that the niche movie 702b is on two VoD-servs 2 and 4. Then, the diagnostic tool 222e checks to make sure that the actual number of VoD-servers in clusters 207d and 207d′ having a given movie 702a and 702b is consistent with the current level of demand by the STBs A, B and C. In this example, the diagnostic tool 222e has the popular movie 702a copied to additional VoD-servers 4 and 5 for possible viewing by STBs A and C. The diagnostic tool 222e determines that two VoD-servers 2 and 4 is adequate for the niche movie 702b which is being viewed by STB B.

### 6. Diagnostic Tool 222f (“VServ_demand”):

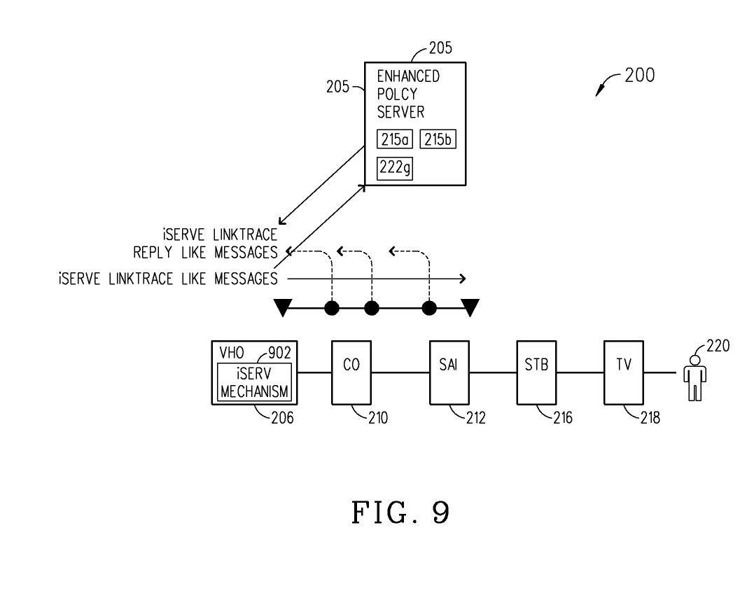

Basic Idea: The enhanced VoD-server controller 207c implements this diagnostic tool 222f to verify the load-balancing of VoD-servers in clusters 207d and 207d′ after a failure and/or repair.
Background/Problem: If a VoD-server fails, STBs which were streaming from it as a primary will switch to their secondary. With the primary VoD-servers, the load was balanced as enforced by a dynamic load-balancer implemented by the VoD-server controller. But the traditional VoD-server controller has nothing which guarantees that the load is balanced between the VoD-server on the post-failure situation. A similar problematic situation can stem from repair events, as well. After a VoD-server comes back to the operational state, its idle capacity could be put to work immediately by diverting some of the content from highly utilized VoD servers. This is not done with the traditional VoD-server controller and traditional VoD-servers.
Solution: The VoD-server controller 207c implements diagnostic tool 222f to verify that the new load on both secondary and primary VoD servers in clusters 207d and 207d′ is balanced after a failure and/or repair event. The diagnostic tool 222f can do this in two ways:
   Reactively: The diagnostic tool 222f whenever a failure and/or repair event happens will wait a predetermined time period (e.g., few seconds) for the STBs 216 to switch to their secondary VoD-servers in clusters 207d and 207d′. Then the diagnostic tool 222f observes the new load, and raises alarms and/or takes corrective action if needed.
   Proactively: The diagnostic tool 222f prior to any failure and/or repair event inspects the STB allocation at the VoD-servers in clusters 207d and 207d′ and then virtually “simulates” failure of each VoD-server, with a program such as the following:
      1. The diagnostic tool 222f obtains the list of STBs 216 using a particular VoD-server as their primary. If this VoD server fails, then these STBs 216 would switch to their respective secondary VoD-servers.
      2. The diagnostic tool 222f obtains the list of VoD-servers used as the secondary by these STBs 216. The diagnostic tool 222f can do this by asking the VoD-server controller 207c (e.g., MOM) or by querying the individual VoD-servers in clusters 207d and 207d′.
      3a. The diagnostic tool 222f verifies whether or not these secondary VoD-servers can handle the additional load. If not, then the diagnostic tool 222f raises an alarm and/or takes corrective action.
      3b. The diagnostic tool 222f verifies whether or not that the load distribution among the secondary VoD-servers is balanced. If not, then the diagnostic tool 222f raises an alarm and/or takes corrective action.
Example: FIG. 8 is provided to help explain how the diagnostic tool 222f verifies the load-balancing of VoD-servers in clusters 207d and 207d′ after a failure or repair. In this example, the diagnostic tool 222f upon learning of the failure of VoD-serv4 waits a predetermined time period (e.g., few seconds) for the STBs A and B to respectively switch to their new secondary VoD-servers VoD-serv2 and VoD-serv3. At this point, STB A is watching a popular movie 802a using primary VoD-serv1 with the backup secondary VoD-serv2 and STB B is watching a niche movie 802b using primary VoD-serv2 with the backup secondary VoD-serv3. STB C is not impacted. The diagnostic tool 222f observes the new load and raises an alarms since VoD-serv2 may have too much load and corrective action may then be taken like adding and copying the popular movie 802a to another VoD-serv6 and instructing the STB A to now use VoD-serv6 as a secondary instead of VoD-serv2 (note: this is a reactive load-balancing process).
   7. Diagnostic Tool 222g (“iServ”):
Basic Idea: The enhanced policy server 205 implements this diagnostic tool 222g to check if the subscriber 220 would indeed be able to receive the service (e.g., BTV channel) as was previously determined by the policy server 205. The diagnostic tool 222g is a per-subscriber, per-service in-band diagnostics tool.
Background/Problem: The traditional policy server and its resulting policy enforcement applies in only one direction which is from the policy server to the downstream network nodes. This happens because the current policy server is assumed to be completely trustworthy. However, the policy server and the corresponding policy enforcement could be functioning as they are supposed to, but this does not necessarily mean that the STB is receiving the service as expected. This is not desirable.
Solution: The enhanced policy server 205 implements diagnostic tool 222g to check if the subscriber 220 is indeed receiving the service (e.g., BTV channel) as was previously determined by the policy server 205. In particular, the diagnostic tool 222g triggers an iServ, a LinkTrace-like tool 902 (ref. IEEE 802.1ag dated May 2006) on a subscriber VLAN to check the service path to the SBT 216 (see FIG. 9). In this example, the VHO 206 is where the iServ is initiated and the replies are received which contain the actual data, such as bandwidth, session, etc., in the intermediate nodes CO 210 and SAI 212. The VHO 206 relays the replies to the policy server 205 which is then able to confirm decisions made by itself about the customer's service request by checking them with the data that was obtained by using the iServ in-band tool 902. In addition, the diagnostic tool 222f can have the iServ in-band tool 902 send a iServ request on a service VLAN to check the health of a particular service (e.g. VOIP) in the IPTV network 200. In either case, the diagnostic tool 222f can be used in either a reactive or a proactive manner. For reactive (subscriber VLAN) diagnostics, the diagnostic tool 222f may be used: (1) just after each service change; (2) just after each policy change due to a new service upgrade request; or (3) before a service admission. While, for proactive (service VLAN) diagnostics, the diagnostic tool 222f may be used: (1) periodically; (2) after some predetermined indications are received; or (3) after a service admission.

From the foregoing, it should be appreciated that the present invention gives operators a set of differentiating diagnostic tools 222a . . . 222f (DServ_failure notification, DServ_feed, DServ_load balance, VServ_content, VServ_failure notification, VServ_demand) to improve their video service and avoid potential delays, load-imbalances, and service unavailabilities. Plus, the policy server's diagnostic tool 222g provides confirmation about the decisions previously made by the policy server 205. In particular, the diagnostic tool 222g provides the ability for the policy server 205 to cross-check on an as-needed proactive basis the information it has about the actual situation (resources) in the IPTV network 200. The diagnostic tools 222a . . . 222g are summarized as follows:

I. The enhanced D-server controller 207a has a memory 211a including processor-executable instructions and a processor 211b operably coupled to the memory 211a where the processor 211b executes the processor-executable instructions to effectuate the performance of one or more of the three diagnostic tools 222a, 222b and 222c (see FIG. 2-5):

a. Diagnostic Tool 222a: “DServ_failure notification”. Proactively notify STBs 216 of a D-server failure for better network efficiency. This D-server may be a primary or a secondary D-server.

b. Diagnostic Tool 222b: “DServ-feed”: Verify that the number of D-servers on which content is residing is proportional to the demand by the STBs 216.

c. Diagnostic Tool 222c: “DServ_load balance”: Check to ensure that the total ICC and retransmission requests are load-balanced among the D-Servers 207b and 207b′. Measure per-channel traffic at D-Server level, and raise alarms if an excess of ICC requests or retransmission requests is detected.

II. The enhanced VoD-server controller 207c has a memory 213a including processor-executable instructions and a processor 213b operably coupled to the memory 213a where the processor 213b executes the processor-executable instructions to effectuate the performance of one or more of the three diagnostic tools 222d, 222e and 222f (see FIG. 2 and 6-8):

a. Diagnostic Tool 222d: “VServ_failure notification”. Proactively, notify STBs 216 about VoD-server failures. Update the STB's secondary VoD-server list so that in case the STB 216 has to switch to its secondary, it is operational right away.

b. Diagnostic Tool 222e: “VServ_content”. Verify that every content (regardless of its popularity) is deployed to at least two VoD-servers. Verify that the number of VoD-servers is proportional to the demand by STBs 216.

c. Diagnostic Tool 222f: “VServ-demand”. If a VoD-server fails, verify that the new load on the secondary VoD-servers is also balanced.

III. The enhanced policy server 205 has a memory 215a including processor-executable instructions and a processor 215b operably coupled to the memory 215a where the processor 215b executes the processor-executable instructions to effectuate the performance of the diagnostic tool 222g (see FIG. 2 and 9):

a. Diagnostic Tool 222g: “iServ”. Check if the subscriber would indeed be able to receive the service as the policy server sees it. It is a per-subscriber, per-service diagnostics tool.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for proactively testing an Internet Protocol Television (IPTV) network, said method comprising the steps of:
proactively detecting a potential problem with at least one component or at least one service within the IPTV network; and
proactively preventing the potential problem with the at least one component or the at least one service within the IPTV network.

2. The method of claim 1, wherein a D-server controller proactively detects and prevents a potential problem by:
retrieving information about a failure or a repair of a D-server; and
informing at least one affected Set-Top-Box (STB) about the failed or repaired D-server, wherein the at least one affected STB then arranges a D-server list to take into account the failed or repaired D-server.

3. The method of claim 1, wherein a D-server controller proactively detects and prevents a potential problem by:
verifying that every Broadcast Television (BTV) channel is in at least one D-Server; and
verifying that a number of the D-servers where each BTV channel resides is proportional to a demand of a plurality of Set-Top-Boxes (STBs).

4. The method of claim 1, wherein a D-server controller proactively detects and prevents a potential problem by:
retrieving Instant Channel Change (ICC) requests and retransmission requests sent by Set-Top-Boxes (STBs); and
load-balancing a plurality of D-Servers if needed based on the retrieved ICC requests and retransmission requests to spread retransmission traffic across the plurality of D-Servers.

5. The method of claim 1, wherein a VoD-server controller proactively detects and prevents a potential problem by:
detecting a failure of a VoD-server;
locating each Set-To-Box (STB) which has the failed VoD-server assigned as a secondary server; and
instructing the located STB(s) to replace a secondary identifier for the failed VoD-server with a new identifier for a new VoD-server which contains a copy of desired content.

6. The method of claim 1, wherein a VoD-server controller proactively detects and prevents a potential problem by:
verifying that a specific content is on at least two VoD-servers, wherein if this condition is not meet than a command is issued to a Super Headend Office (SHO) to copy the specific content to at least one new VoD-server for redundancy; and
verifying that a number of VoD-servers owning the specific content is proportional to a current demand for the specific content by a plurality of Set-Top-Boxes (STBs), wherein if this condition is not met then a command is issued to the SHO to copy the specific content to at least one new VoD-server.

7. The method of claim 1, wherein a VoD-server controller proactively detects and prevents a potential problem by:
verifying that a new load on both secondary and primary VoD-servers of each STB is balanced after one of a plurality of VoD-servers has failed or has been repaired.

8. The method of claim 7, wherein said verifying step includes:
waiting a predetermined time period for at least one Set-Top-Box (STB) to switch to their secondary VoD-servers whenever one of the VoD-servers has failed or has been repaired; and
observing the new load on both the secondary and primary VoD-servers and if needed raising an alarm or taking a corrective action to balance the new load on the VoD-servers.

9. The method of claim 7, wherein said verifying step includes:
inspecting an allocation of Set-To-Boxes (STBs) to the VoD-servers; and
virtually simulating a failure of at least one of the VoD-servers prior to any failure event or any repair event and observing the new load on both the secondary and primary VoD-servers of each STB and learning if corrective would be needed to balance the new load on the VoD-servers.

10. The method of claim 1, wherein a policy server proactively detects and prevents a potential problem by:
checking if a subscriber is indeed receiving a service as was previously determined by the policy server, wherein said checking step further includes the steps of:
triggering a trace message on a subscriber VLAN or a service VLAN to be sent from a Video Hub Office (VHO) towards a Set-Top-Box (STB) associated with the subscriber;
receiving replies to the trace message from components located on a path between the VHO and the STB;
using the replies to confirm whether or not the subscriber is indeed receiving the service as was previously determined by the policy server.

11. A server that implements at least one diagnostic tool to proactively test an Internet Protocol Television (IPTV) network, said server comprising:
a memory that stores processor-executable instructions;
a processor that interfaces with the memory and executes the processor-executable instructions to effectuate performance of at least one diagnostic test comprising:
proactively detecting a potential problem with at least one component or at least one service within the IPTV network; and
proactively preventing the potential problem with the at least one component or the at least one service within the IPTV network.

12. The server of claim 11, wherein the server is a D-server controller which proactively detects and prevents a potential problem by:
retrieving information about a failure or a repair of a D-server; and
informing at least one affected Set-Top-Box (STB) about the failed or repaired D-server, wherein the at least one affected STB then arranges a D-server list to take into account the failed or repaired D-server.

13. The server of claim 11, wherein the server is a D-server controller which proactively detects and prevents a potential problem by:
verifying that every Broadcast Television (BTV) channel is in at least one D-Server; and
verifying that a number of the D-servers where each BTV channel resides is proportional to a demand of a plurality of Set-Top-Boxes (STBs).

14. The server of claim 11, wherein the server is a D-server controller which proactively detects and prevents a potential problem by:
retrieving Instant Channel Change (ICC) requests and retransmission requests sent by Set-Top-Boxes (STBs); and
load-balancing a plurality of D-Servers if needed based on the retrieved ICC requests and retransmission requests to spread retransmission traffic across the plurality of D-Servers.

15. The server of claim 11, wherein the server is a VoD-server controller which proactively detects and prevents a potential problem by:
detecting a failure of a VoD-server;
locating each Set-To-Box (STB) which has the failed VoD-server assigned as their secondary server; and
instructing the located STB(s) to replace a secondary identifier for the failed VoD-server with a new identifier for a new VoD-server which contains a copy of desired content.

16. The server of claim 11, wherein the server is a VoD-server controller which proactively detects and prevents a potential problem by:
verifying that a specific content is on at least two VoD-servers, wherein if this condition is not meet than a command is issued to a Super Headend Office (SHO) to copy the specific content to at least one new VoD-server for redundancy; and
verifying that a number of VoD-servers owning the specific content is proportional to a current demand for the specific content by a plurality of Set-Top-Boxes (STBs), wherein if this condition is not met then a command is issued to the SHO to copy the specific content to at least one new VoD-server.

17. The server of claim 11, wherein the server is a VoD-server controller which proactively detects and prevents a potential problem by:
verifying that a new load on both secondary and primary VoD-servers of each STB is balanced after one of a plurality of VoD-servers has failed or has been repaired.

18. The server of claim 17, wherein said verifying operation includes:
waiting a predetermined time period for at least one Set-Top-Box (STB) to switch to their secondary VoD-servers whenever one of the VoD-servers has failed or has been repaired; and
observing the new load on both the secondary and primary VoD-servers and if needed raising an alarm or taking a corrective action to balance the new load on the VoD-servers.

19. The server of claim 17, wherein said verifying operation includes:
inspecting an allocation of Set-To-Boxes (STBs) to the VoD-servers; and
virtually simulating a failure of at least one of the VoD-servers prior to any failure event or any repair event and observing the new load on both the secondary and primary VoD-servers of each STB and learning if corrective action would be needed to balance the new load on the VoD-servers.

20. The server of claim 11, wherein the server is a policy server which proactively detects and prevents a potential problem by:
checking if a subscriber is indeed receiving a service as was previously determined by the policy server, wherein said checking step further includes the steps of:
triggering a trace message on a subscriber VLAN or a service VLAN to be sent from a Video Hub Office (VHO) towards a Set-Top-Box (STB) associated with a subscriber;
receiving replies to the trace message from components located on a path between the VHO and the STB;
using the replies to confirm whether or not the subscriber is indeed receiving the service as was previously determined by the policy server.

21. An Internet Protocol Television Network (IPTV) comprising:
a D-server controller which proactively detects and prevents potential problems by implementing:
a first diagnostic tool that retrieves information about a failure or a repair of a D-server, and informs at least one affected Set-Top-Box (STB) about the failed or repaired D-server, wherein the at least one affected STB then arranges a D-server list to take into account the failed or repaired D-server;
a second diagnostic tool that verifies every Broadcast Television (BTV) channel is in at least one D-Server, and verifies that a number of the D-servers where each BTV channel resides is proportional to a demand the STBs; and/or
a third diagnostic tool that retrieves Instant Channel Change (ICC) requests and retransmission requests sent by the STBs, and load-balances the D-Servers if needed based on the retrieved ICC requests and retransmission requests to spread retransmission traffic across the D-Servers;
a VoD-server controller which proactively detects and prevents a potential problem by implementing:
a fourth diagnostic tool that detects a failure of a VoD-server, locates each STB which has the failed VoD-server assigned as s secondary server, and instructs the located STB(s) to replace a secondary identifier for the failed VoD-server with a new identifier for a new VoD-server which contains a copy of desired content;
a fifth diagnostic tool which verifies that a specific content is on at least two VoD-servers, and verifies that a number of VoD-servers owning the specific content is proportional to a current demand for the specific content from the STBs; and/or
a sixth diagnostic tool that verifies a new load on both secondary and primary VoD-servers of each STB is balanced after one of a plurality of VoD-servers has failed or has been repaired; and/or
a policy server which proactively detects and prevents a potential problem by implementing:
a seventh diagnostic tool that checks if a subscriber is indeed receiving a service as was previously determined by the policy server.
